(19) United States
(12) Patent Application Publication
(10) Pub. No.: US 2014/0114678 A1
(43) Pub. Date: Apr. 24, 2014

(54) SECURE DELIVERY OF PERSONALIZED NEUROMODULATION TREATMENT PROTOCOLS ACROSS THE INTERNET TO A STIMULATOR DEVICE

(71) Applicants: Eric P. MOYER, Huntington Beach, CA (US); Peter TOICH, Evesham, NJ (US); Joseph R. WINSTON, Raleigh, NC (US)

(72) Inventors: Eric P. MOYER, Huntington Beach, CA (US); Peter TOICH, Evesham, NJ (US); Joseph R. WINSTON, Raleigh, NC (US)

(21) Appl. No.: 14/062,526

(22) Filed: Oct. 24, 2013

Related U.S. Application Data
(60) Provisional application No. 61/717,936, filed on Oct. 24, 2012.

(51) Int. Cl. G06F 19/00

(52) U.S. Cl. CPC G06F 19/3418
USPC 705/2

(57) ABSTRACT

This invention manages the variation of neuromodulation sequences inherent in effective treatment for poly-substance abuse and dependence through downloadable neuromodulation protocols for common poly-substance combinations. The substance abuse profiles and the poly-substance neuromodulation protocols are placed on an Internet connected server, allowing effective management of complex treatments via network-attached client software to addiction clinics in most of the geographic areas in the world. Such downloadable protocols may be selected based on the addict's presenting drugs, drug history (from the addict and from appropriate medical personnel), health deficits (e.g. compromised liver) and other factors. Modifications to the downloaded protocol may become desirable as acute withdrawal symptoms emerge or other new information regarding the patient's condition becomes available. The treatment protocol may be changed during the patient's treatment through the download of different protocols dynamically adjustable treatment parameters under control of the treatment provider.

### CROSS-REFERENCE TO RELATED APPLICATIONS

This application is based on, and claims priority to U.S. Provisional Application No. 61/717,936, filed Oct. 24, 2012, the entire contents of which is fully incorporated herein by reference.

### BACKGROUND OF THE INVENTION

In typical implementations of CES (cranial electrotherapy stimulation) stimulator devices, TENS (transcutaneous electrical nerve stimulation) devices and other commercially available electrical stimulators, the device will have user controls (e.g. knobs, buttons, sliders) to allow the user to select the wave shape, frequency, pulse width, modulation, intensity, and/or other waveform characteristics for the stimulation being applied. When using neuromodulation to address addiction and substance abuse, the selection and timing of waveforms within a single- or poly-substance protocol is sufficiently complex to render manual control arduous and prone to failure.

Personalized Treatment Protocols

In order to manage neuromodulation protocols for poly-substance abuse, the logistics of maintaining and selecting stored protocols within the device or the use of external pluggable data storage modules becomes impractical. The patterns of addictive substance consumption in many populations now encompass a dozen or more different substances (e.g. heroin, methadone, oxycodone, hydrocodone, fentanyl, oxymorphone, buprenorphine, codeine, dihydrocodeine, cocaine, crack, alcohol, nicotine, amphetamine, methamphetamine, marijuana, valium and other benzodiazepines). The number of poly-substance neuromodulation protocols required to cover all possible combinations of treatable substances is unmanageably large, and is further increased due to the temporally staggered onset of acute withdrawal symptoms. The addict will not take the most recent dose of each substance at the same time, and each substance has a different delay period to the onset of acute withdrawals.

While it is possible to have device software store and manage multiple poly-drug protocols, stimulator devices are typically small and portable, making the user interface for such a process difficult to use. In addition, control of such management is typically under the control of the treatment provider and not the patient.

### SUMMARY OF THE INVENTION

This invention manages the variation of neuromodulation sequences inherent in effective treatment for poly-substance abuse and dependence through downloadable neuromodulation protocols for common poly-substance combinations. Such downloadable protocols may be selected based on the addict's presenting drugs, drug history (from the addict and from appropriate medical personnel), health deficits (e.g. compromised liver) and other factors. Modifications to the downloaded protocol may become desirable as acute withdrawal symptoms emerge or other new information regarding the patient's condition becomes available. The treatment protocol may be changed during the patient's treatment through the download of different protocols dynamically adjustable treatment parameters under control of the treatment provider.

By placing the substance abuse profiles and the poly-substance neuromodulation protocols on an Internet connected server, the complexity of treatment management can be effectively managed and made available via network-attached client software to addiction clinics in most of the geographic areas in the world. In addition, such a model supports a payment-per-treatment business model.

### BRIEF DESCRIPTION OF THE DRAWINGS

FIGS. 1-26 illustrate elements and functions of the invention described herein.

### DETAILED DESCRIPTION

Treatment Management

Network-attached client software provides the following functions:
1) Secure login/operator identification
2) Password recovery
3) Online Help
4) Patient Browser
5) Entry of addict information, including name, date of birth, handedness, gender, drug-taking history, treatment history and other pertinent information specific to the addict receiving treatment
6) Downloadable protocol selection
7) Treatment control, including start, stop, change device, change protocol, discharge.
8) Withdrawal severity score entries
9) Text chat with support staff
10) Device status reporting
11) Internal device status, such as battery voltage level, intensity knob history, output impedance history, hardware and software identifiers, treatment state
12) Patient-specific support printouts
13) Account Management, including facility management (create, identify, delete, group, set parameters, enable treatment protocols), practitioner management (create, information, delete, group, set parameters)
14) Automatic software updates, optional or mandatory
15) Device management by type and serial number.

Secure Transmission

This invention uses symmetric encryption (where the same key is used for encryption and decryption) to protect the transfer of message data between the device and the client. Matching transport keys are stored in the client and device to encrypt and decrypt communications. Checksums are used to validate successful transfer and removal of the encryption layer.

This invention also uses symmetric encryption to protect the transfer of treatment protocol data between the server and the device. Matching protocol keys are stored in the server and the device to encrypt and decrypt communications. CRCs are used to validate successful transfer and removal of the encryption layer.

This invention uses (SSL) encryption to protect the transfer of message data between the server and the client.

Connectivity

In the embodiment shown in FIG. 1, the device (1) is typically a portable battery-powered stimulation device, but could also be a desk-top model powered by the main electrical power service provided to a house, building or other location of a power outlet from which to power the non-portable device. The device provides a USB local data connection (2), but could also use a serial port, parallel port, firewire, ethernet, Wi-Fi, WiMax, Bluetooth, UWB, Infrared, packet radio, GSM, GPRS, Edge, CDMA, 3G, 4G, or other wired or wireless data path. The data path connects to a local workstation (3), but could also connect to a laptop, tablet, smart phone or other fixed or portable computing system.

The workstation (3) acts as a network client, and provides an Ethernet network connection (4). The connection could also be a serial port, parallel port, firewire, ethernet, Wi-Fi, WiMax, Bluetooth, UWB, Infrared, packet radio, GSM, GPRS, Edge, CDMA, 3G, 4G, T1 or other wired or wireless network connection. The network connection provides access to the Internet (5) either directly or indirectly. The network could also be any public or private wired or wireless network. Also connected to the network (5) is a Server Site (7). This site could be co-located with or separate from the Client Site where the workstation (3) is located. Within the Server Site (7) is one or more Backend Servers (8), connected to the network with one or more Ethernet connections (6). The network connections could also be serial port, parallel port, firewire, ethernet, Wi-Fi, WiMax, Bluetooth, UWB, Infrared, packet radio, GSM, GPRS, Edge, CDMA, 3G, 4G, T1 or other wired or wireless network connections.

Secure Data Paths

The invention secures the data paths between the server and the device by encrypting all traffic between the server and client and encrypting all traffic between the client and device. Validity of the data is checked at the destination using CRC, checksums or other methods.

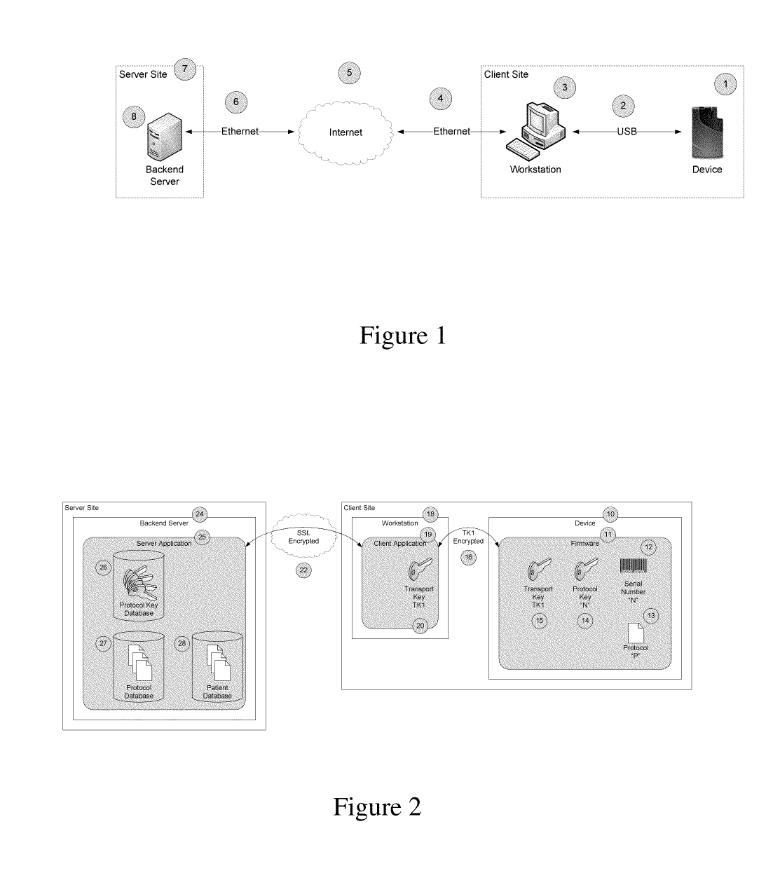

In the embodiment shown in FIG. 2, the Device (10) runs operating Firmware (11), contains the Device's unique Serial Number (12) and the Protocol (13) being delivered to the patient, and contains a Protocol Key (14) and Transport Key (15).

The Workstation (18) runs the Client Application (19) and contains a Transport Key (20) for communications with the Device (10). Communications (16) between the Workstation (18) and Device (10) are encrypted at source and decrypted at destination using the Transport Keys located in the Workstation (20) and Device (15), respectively, and the data validity is verified using a checksum.

The Backend Server (24) runs the Server Application (25) and contains the Protocol Key Database (26), Protocol Database (27) and Patient Database (28). Communications (22) between the Server (24) and Workstation (18) are encrypted at source and decrypted at destination using SSL.

Secure Delivery of the Protocol

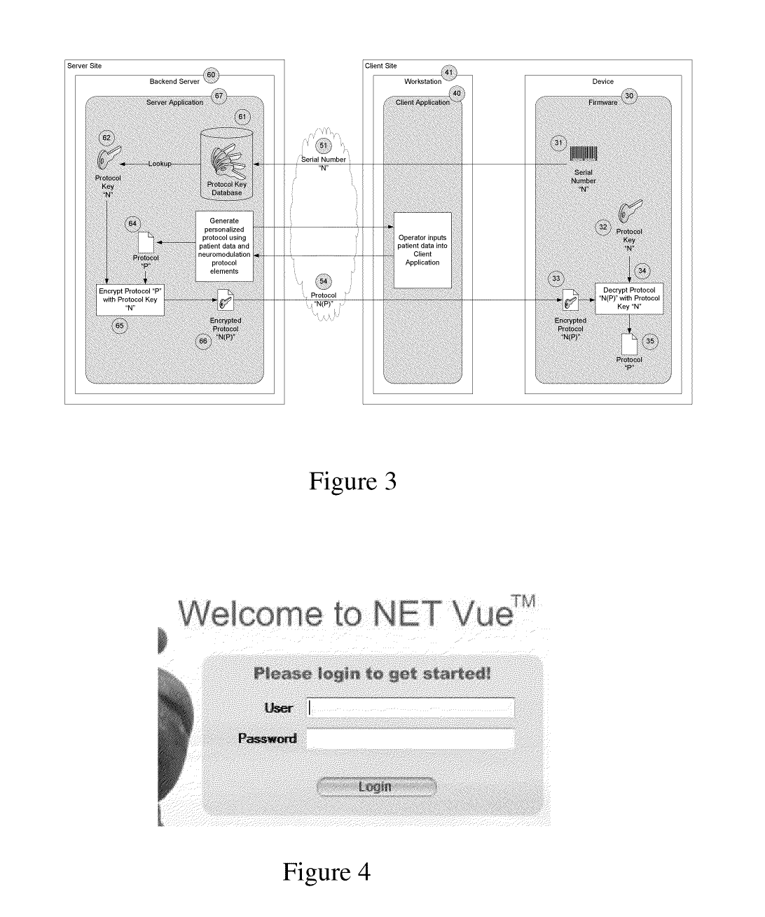

Referring now to FIG. 3, in order to encrypt the Protocol (64), the Server Application (67) securely obtains (51) the unique Serial Number (31) from the device Firmware (30), and uses that Serial Number to lookup the Protocol Key (62) in the Protocol Key Database (61). The Server Application (67) then uses the Protocol Key (62) to encrypt the Protocol (64) and produce (65) an Encrypted Protocol (66).

The Encrypted Protocol (66) is transferred securely (54) to the Device (33). The Firmware (30) uses its internal Protocol Key (32) to decrypt the Encrypted Protocol (33) and to produce (34) the Personalized Protocol (35). Data validity is checked using CRC.

The device is now ready to deliver the protocol to the patient.

Treatment Management

The Client Application (19) provides the following treatment management functions:

Secure login/operator identification (FIG. 4)

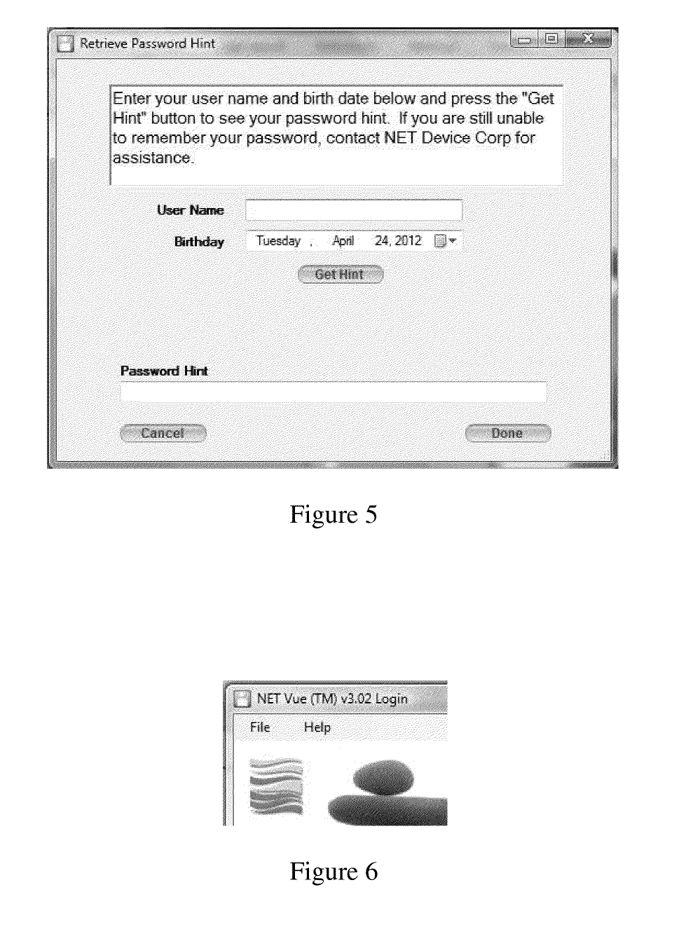

Password recovery (FIG. 5)

Online Help (FIG. 6)

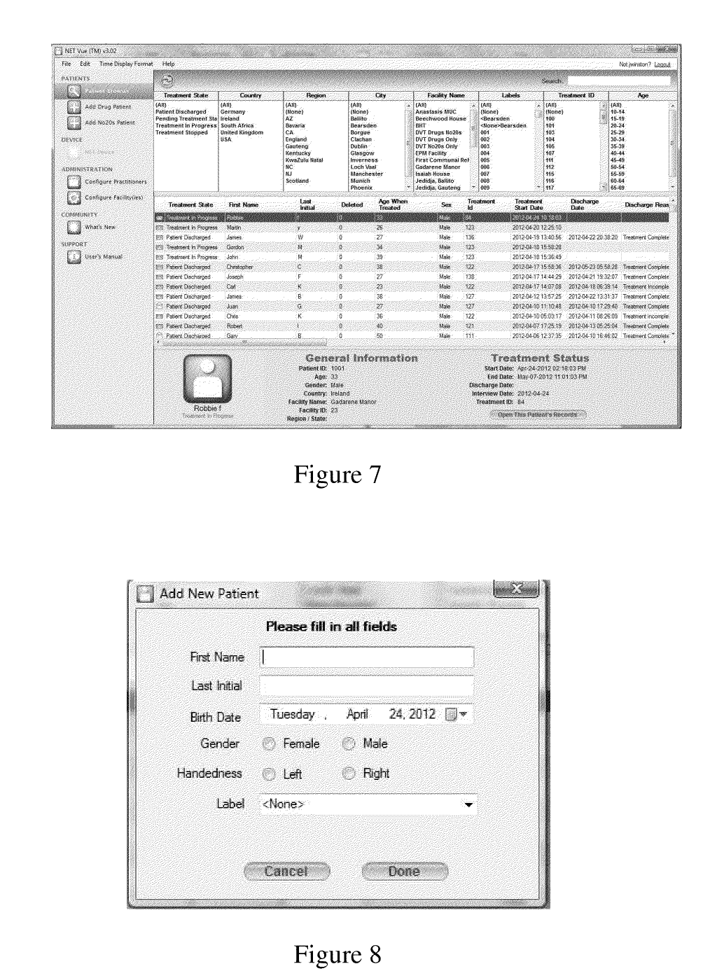

Patient Browser, allowing filtering and sorting based on Treatment State, Country, Region, City, Facility, User Defined Labels, Treatment ID, Age and other categories. (FIG. 7)

Add new a new patient to the system, including name, date of birth, gender, handedness, and user defined label. (FIG. 8)

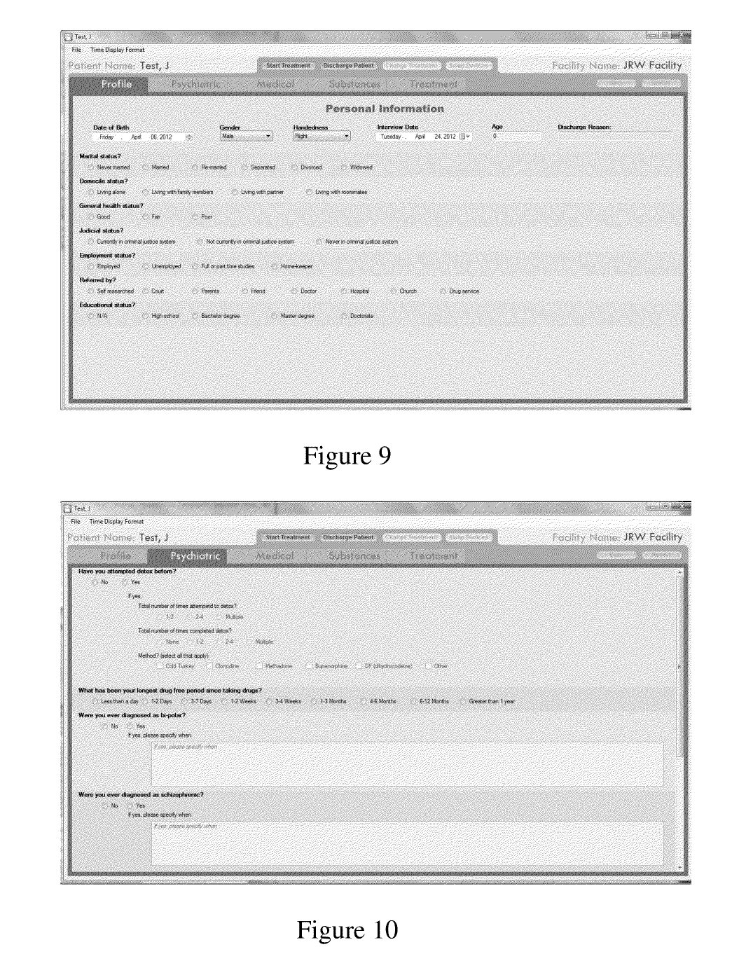

Entry of patient personal history, including marital status, domicile, general health, judicial status, employment, education, and referral source. (FIG. 9)

Entry of patient psychiatric history, including detoxification history and history of diagnosed psychiatric illness. (FIG. 10)

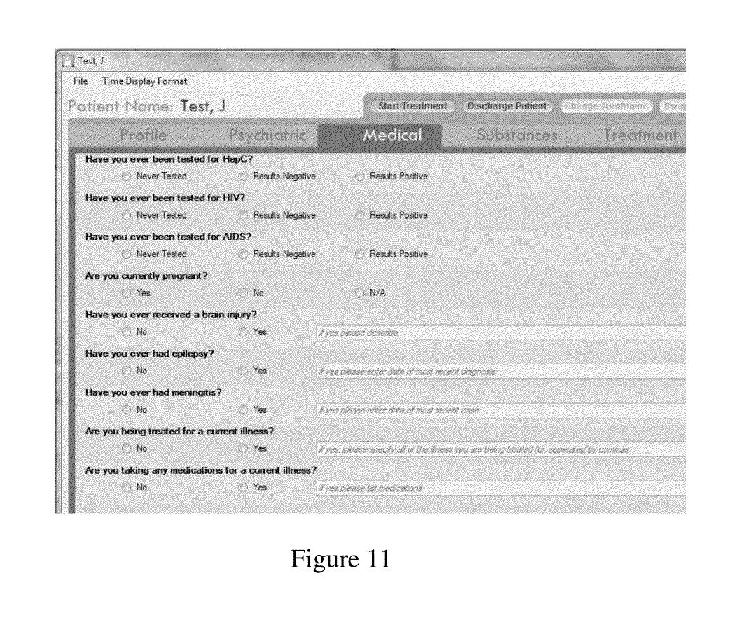

Entry of patient medical history, including blood borne viruses and any contraindicated conditions for treatment (FIG. 11)

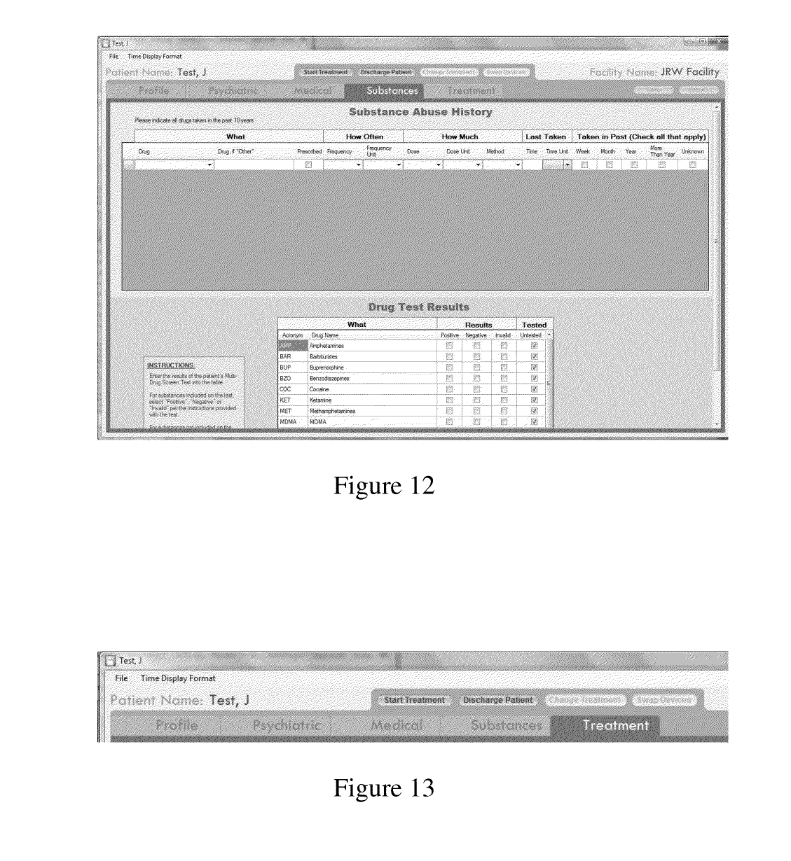

Entry of patient substance abuse history (FIG. 12)

Treatment Start (FIG. 13)

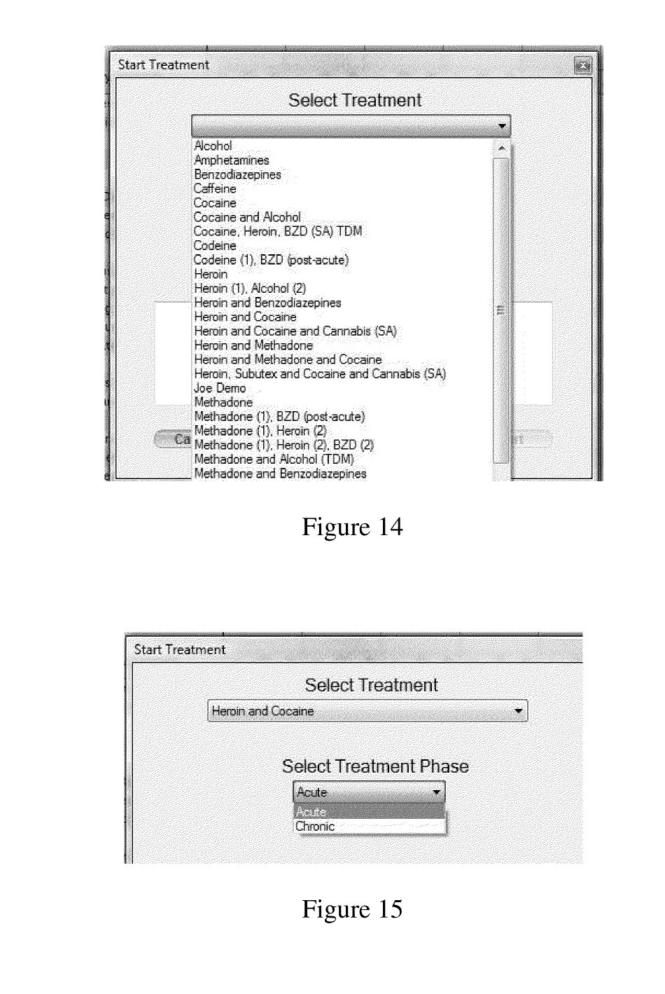

Select a protocol for download (FIG. 14)

Select a treatment phase for the downloaded protocol (FIG. 15)

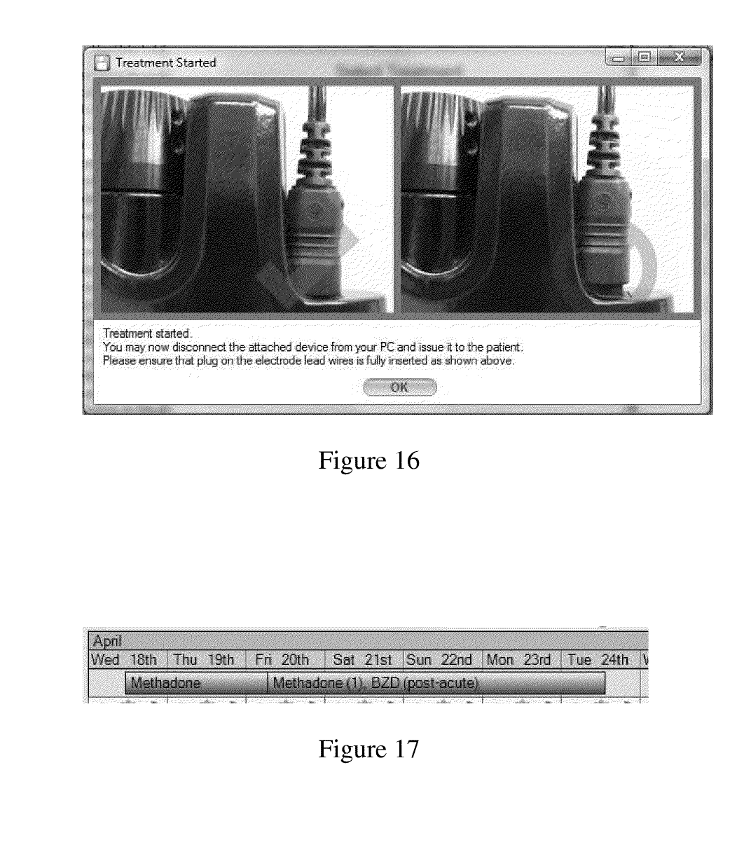

Provide treatment provider cautions and information (FIG. 16)

Display treatment progress, including current and past downloaded protocols, schedule of treatment. (FIG. 17)

Collect withdrawal severity reports from the patient and display the report history in tabular and graphical form (FIG. 18)

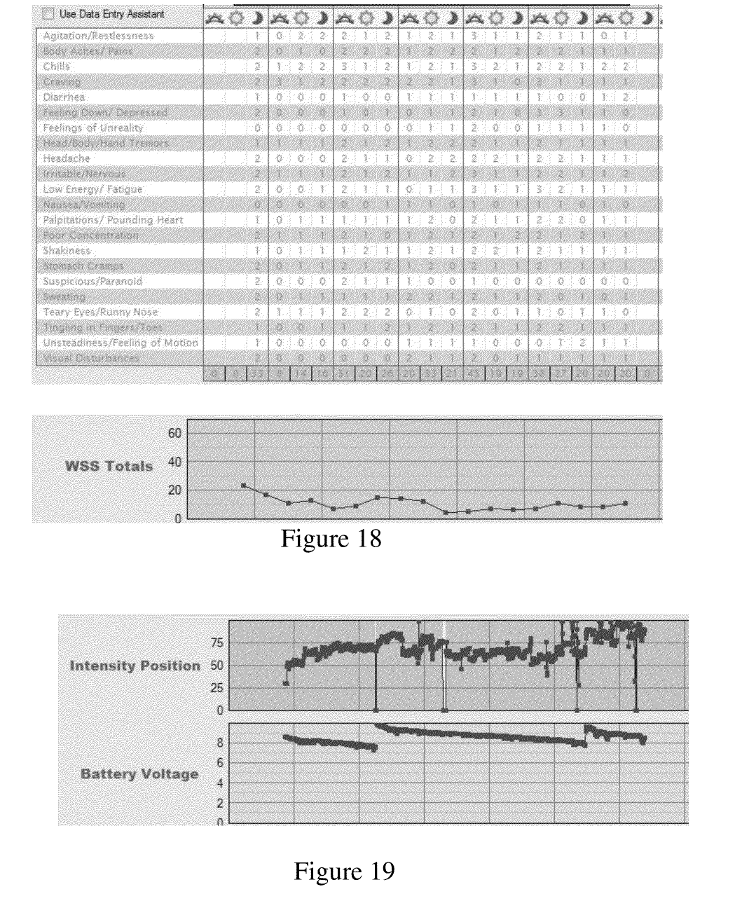

Obtain and display device status, such as battery voltage level, intensity knob history and output impedance history. (FIG. 19)

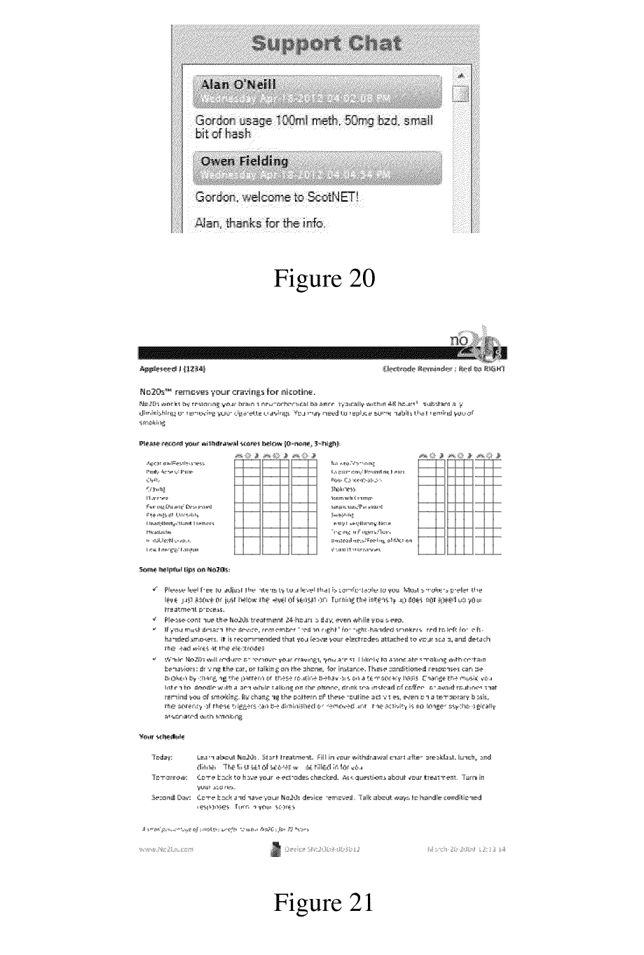

Provide real time text chat between treatment staff and support staff (FIG. 20)

Provide patient-specific support printouts (FIG. 21)

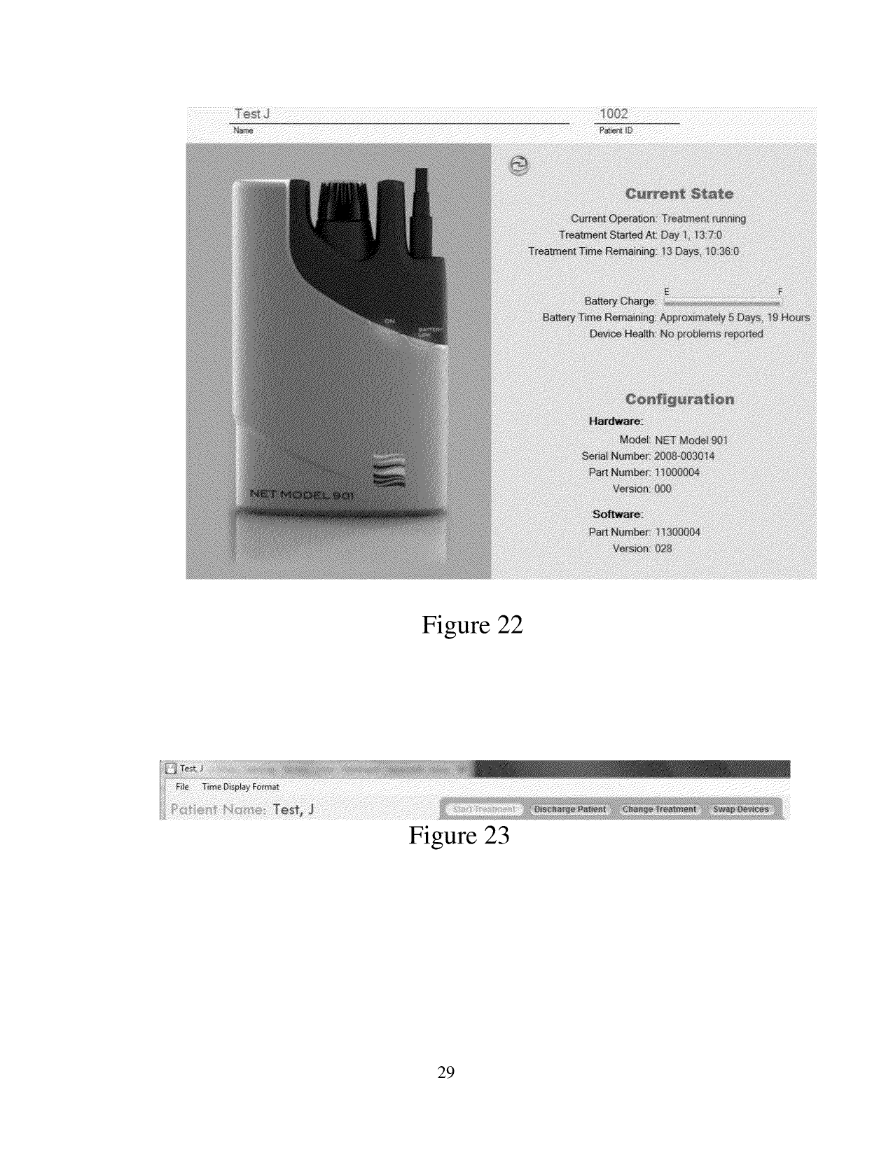

Obtain and display device-specific information, including operational state, treatment start time, treatment time remaining, battery level, battery time remaining, device health, hardware model, serial number, part number and revision number, software part number and revision. (FIG. 22)

Treatment control, including change treatment, swap devices and discharge patient. (FIG. 23)

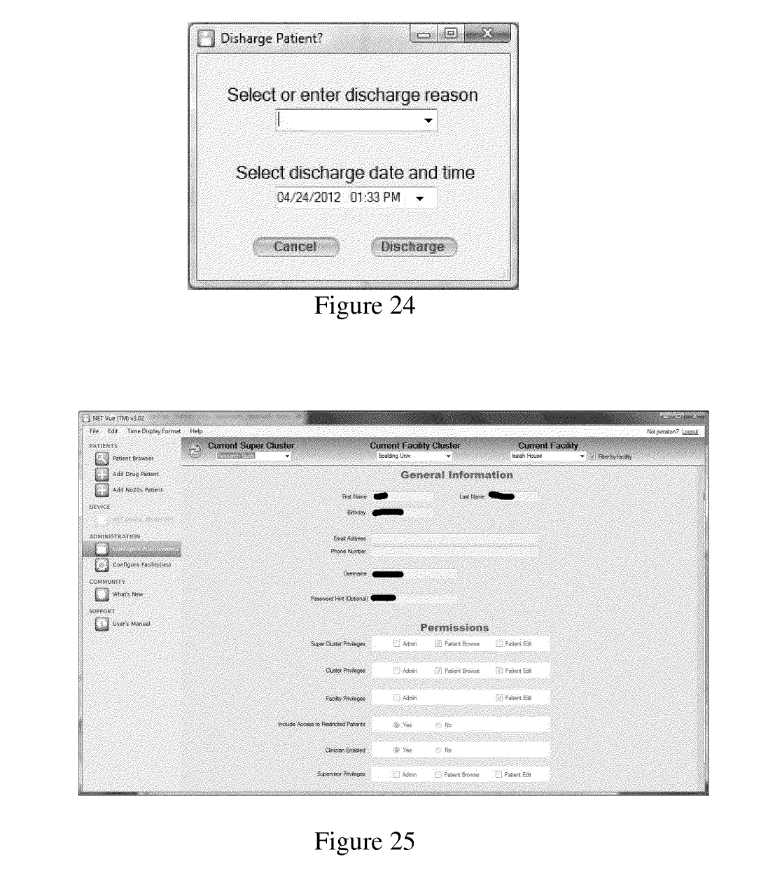

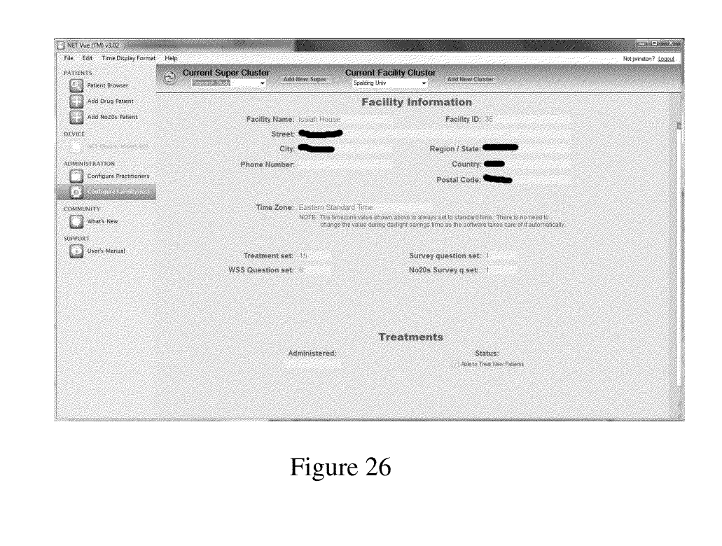

Treatment practitioner management, including name, birthdate (for password retrieval), contact information, username, password hint, and permissions (FIG. 24)

Facility management, including facility name, facility ID, address, contact information, time zone, set of permissible treatment protocols, set of patient history questions, and service status. (FIG. 25)

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions. For example, the encryption and decryption functions can be performed using a standard commercial low-power microcontroller with separate code and data spaces (Harvard architecture), internal volatile and non-volatile storage, and onboard peripheral support. Network connectivity can be via USB, using an industry standard USB-to-serial UART, or via WiFi and 4G using standard industry chipsets coupled to the microcontroller peripherals of the devices.

The program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

1. A method for delivering data comprising one or more neuromodulation waveform descriptions, comprising:
configuring a stimulation device with data connectivity capability to enable the stimulation device to send and receive data;
configuring a server with data connectivity capability to enable the server to send data to and receive data from said stimulation device; wherein data sent to said stimulation device includes neuromodulation waveform descriptions processed by a processor of said stimulation device to control delivery of therapeutic stimulation by said stimulation device.

2. The method of claim 1, wherein said data sent to said stimulation device further includes one or more of treatment load, treatment start, treatment stop, status request, firmware load, firmware select, device enable, device disable, and device restart information.

3. The method of claim 1, wherein said stimulation device is configured to send data to said server, and wherein data sent to said server from said stimulation device includes status information regarding said stimulation device.

4. The method of claim 3, wherein said status information includes one or more of intensity knob position, battery voltage, battery time remaining, output voltage, output current, output frequency, output pulse width, output modulation, device operational state, treatment start time, treatment stop time, treatment time remaining, treatment identifier, treatment state, device model, device serial number, device part number, device revision number, firmware description, firmware part number, firmware revision number, device health, device error status, hardware status log, and firmware status log information.

5. The method of claim 4, wherein said data sent to said stimulation device further includes one or more of treatment load, treatment start, treatment stop, status request, firmware load, firmware select, device enable, device disable, and device restart information.

6. The method of claim 5, further comprising:
configuring a client to facilitate the transfer of data between said stimulation device and said server.

7. The method of claim 6, wherein data transferred between the server and the stimulation device, between the server and the client, and between the client and the device is encrypted.

8. The method of claim 6, wherein one or more treatment management functions are provided at at least one of the server, client and stimulation device.

9. A method of claim 8, wherein treatment management functions include entry, edit, control, display, filtering and/or ordering of information regarding patients treated, in treatment and/or pending treatment.

10. A method of claim 9, wherein information includes one or more of patient name, address, birth date, age, gender, handedness, marriage history, domicile, general health, drug abuse history, medical history, psychiatric history, prescription history, substance abuse history, detoxification history, blood-borne virus history, treatment contraindications, judicial history, employment history, education history, referral source, and other patient-related characteristics.

11. A method of claim 9, wherein information includes one or more of treatment start date and/or time, treatment completion date and/or time, duration of treatment, treatment state, treatment type, treatment data, device identifying data, device history, device operational data, and other treatment delivery characteristics.

12. A method of claim 9, wherein information includes one or more of facility name, location, ownership, staff, and other facility characteristics.

13. A method of claim 9, wherein information includes one or more of cost of treatment, price of treatment, state of invoice, state of payment, state of collection, and other financial characteristics.

14. A method of claim 8, wherein treatment management functions include control and/or display of one or more of new patient, start patient, discharge patient, discharge reason, treatment start, treatment stop, treatment pause, treatment selection, treatment phase, treatment change, and device change.

15. A method of claim 8, wherein treatment management functions include display of cautions and/or other information to the treatment provider, facility, user and/or patient.

16. A method of claim 8, wherein treatment management functions include control and/or display of withdrawal severity reports and other substance withdrawal status.

17. A stimulation device for delivering neuromodulation sequences to a user of the device, said stimulation device being configured with hardware enabling the stimulation device with data connectivity capability to enable the stimulation device to send and receive data.

18. The stimulation device of claim 17, wherein said stimulation device is further configured with software enabling the stimulation device with data connectivity capability to enable the stimulation device to send and receive data.

19. A system for delivering data comprising one or more neuromodulation waveform descriptions, comprising:
a stimulation device configured with data connectivity capability to enable the stimulation device to send and receive data;
a server configured with data connectivity capability to enable the server to send data to and receive data from said stimulation device; wherein data sent to said stimulation device includes neuromodulation waveform descriptions processed by a processor of said stimulation device to control delivery of therapeutic stimulation by said stimulation device.

20. The system of claim 19, wherein said data sent to said stimulation device further includes one or more of treatment load, treatment start, treatment stop, status request, firmware load, firmware select, device enable, device disable, and device restart information.
